(19) United States
(12) Patent Application Publication
(10) Pub. No.: US 2026/0264138 A1
(43) Pub. Date: Sep. 10, 2026

(54) INJECTION MOLDING MACHINE, RECYCLING SYSTEM, AND RECYCLING METHOD

(71) Applicant: THE JAPAN STEEL WORKS, LTD., Tokyo (JP)

(72) Inventor: Michio BUTANI, Tokyo (JP)

(21) Appl. No.: 19/549,799

(22) Filed: Feb. 25, 2026

(30) Foreign Application Priority Data
Mar. 10, 2025 (JP) 2025-037558

(51) Int. Cl. B22D 17/20; B02C 23/08; B03C 1/30

(52) U.S. Cl. CPC B22D 17/20; B02C 23/08; B03C 1/30

(57) ABSTRACT

An injection molding machine according to an embodiment includes: a first feeder configured to supply raw-material chips made of virgin material to a barrel; a second feeder configured to supply raw-material chips made of recycled material obtained by pulverizing metal scrap generated from the injection molding machine; and a controller configured to control the first and second feeders. The controller controls the first and second feeders so as to add the recycled material to the virgin material at a mass ratio within a predetermined range.

### INCORPORATION BY REFERENCE

This application is based upon and claims the benefit of priority from Japanese patent application No. 2025-037558, filed on Mar. 10, 2025, the disclosure of which is incorporated herein in its entirety by reference.

### BACKGROUND

The present disclosure relates to an injection molding machine, a recycling system, and a recycling method.

As disclosed in Patent Literature 1, a recycling method in which scrap made of a magnesium alloy generated in injection molding is reused is known.

[Patent Literature 1] Japanese Unexamined Patent Application Publication No. 2000-033279

### SUMMARY

The inventors have found various problems related to recycling of metal scrap such as a magnesium alloy generated in injection molding.

For example, injection molding using raw-material chips made of recycled material, obtained by pulverizing metal scrap is advantageous in terms of the cost. However, for metal molded articles using such raw-material chips made of recycled material, there has been a problem that, for example, the concentration of Fe tends to exceed the upper limit value.

Other problems and new features will become apparent from the description in this specification and the accompanying drawings.

An injection molding machine according to an embodiment includes:

a first feeder configured to supply raw-material chips made of virgin material to a barrel (cylinder);

a second feeder configured to supply raw-material chips made of recycled material, obtained by pulverizing metal scrap generated from the injection molding machine; and

a controller configured to control the first and second feeders, in which

the controller controls the first and second feeders so as to add the recycled material to the virgin material at a mass ratio within a predetermined range.

In a recycling system according to an embodiment,

an injection molding machine to which raw-material chips made of recycled material, obtained by a pulverizer are supplied includes:

a first feeder configured to supply raw-material chips made of virgin material to a barrel;

a second feeder configured to supply the recycled material to a barrel; and

a controller configured to control the first and second feeders, in which

the controller controls the first and second feeders so as to add the recycled material to the virgin material at a mass ratio within a predetermined range.

In a recycling method according to an embodiment,

an injection molding machine to which raw-material chips made of recycled material, obtained by crushing and pulverizing metal scrap is supplied incudes: a first feeder configured to supply raw-material chips made of virgin material to a barrel;

a second feeder configured to supply the recycled material to the barrel; and

a controller configured to control the first and second feeders, in which

in an injection molding step, the controller controls the first and second feeders so as to add the recycled material to the virgin material at a mass ratio within a predetermined range.

According to the embodiments, it is possible to provide an injection molding machine that can reduce the manufacturing cost while preventing the concentration of Fe from exceeding the upper limit value.

The above and other objects, features and advantages of the present disclosure will become more fully understood from the detailed description given hereinbelow and the accompanying drawings.

### BRIEF DESCRIPTION OF DRAWINGS

FIG. 1 is a block diagram showing a configuration of a recycling system according to a first embodiment;

FIG. 2 shows macro photographs showing a process through which raw-material chips made of recycled material are obtained from metal scrap;

FIG. 3 is a schematic cross-sectional diagram showing a configuration of an injection molding machine according to the first embodiment;

FIG. 4 is a schematic cross-sectional diagram showing the configuration of the injection molding machine according to the first embodiment;

FIG. 5 is a schematic cross-sectional diagram showing the configuration of the injection molding machine according to the first embodiment;

FIG. 6 is a block diagram showing a configuration of a recycling system according to a second embodiment;

FIG. 7 shows macro photographs showing how raw-material chips made of recycled material are classified according to the size by a particle-classifying apparatus 60; and

FIG. 8 is a schematic cross-sectional diagram showing an example of a magnetic substance removing apparatus 50 and a particle-classifying apparatus 60.

### DESCRIPTION OF EMBODIMENTS

Specific embodiments will be described hereinafter in detail with reference to the drawings. However, the present disclosure is not limited to the embodiments described below. Further, in order to clarify the description, the following description and the drawings are simplified as appropriate.

### First Embodiment

### Configuration of Recycling System

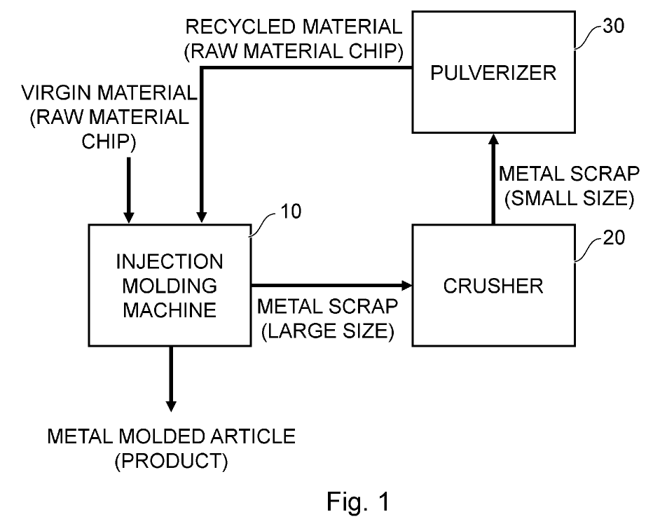

Firstly, a configuration of a recycling system according to a first embodiment will be described with reference to FIG. 1. FIG. 1 is a block diagram showing the configuration of the recycling system according to the first embodiment. As shown in FIG. 1, the recycling system according to this embodiment includes an injection molding machine 10, a crusher 20, and a pulverizer 30.

As shown in FIG. 1, in the injection molding machine 10, raw-material chips made of virgin material and raw-material chips made of recycled material are supplied. Then, a metal molded article(s) (product(s)) is injection-molded, and metal scrap is generated. Note that the metal scrap is, for example, parts other than the product in the metal molded article, and specifically, is sprues, runners, gates, and the like.

The injection molding machine 10 according to this embodiment is an injection molding machine for thixomolding in which, for example, molten (or semi-molten) metal material is injected. The metal material to be injected is not limited to any particular material. For example, the metal material to be injected is metal material containing magnesium as the main component. The magnesium alloy is, for example, but not limited to, AZ91D, AM60B, or the like. Further, the metal material to be injected may be metal material containing zinc or lead as the main component.

Details of the injection molding machine 10 will be described later.

The crusher 20 crushes the metal scrap generated in the injection molding machine 10 into pieces of a certain size. The crusher 20 is not limited to any particular crushers. For example, the crusher 20 is a shearing-type twin-axis crusher.

The pulverizer 30 pulverizes the metal scrap crushed by the crusher 20 into raw-material chips. The raw-material chips made of recycled material, obtained by the pulverizer 30 are supplied to the injection molding machine 10. The pulverizer 30 is also not limited to any particular pulverizers. For example, the pulverizer 30 is a shearing-type single-axis pulverizer for pulverizing metal scrap by a shearing force that occurs between a rotary blade and a fixed blade.

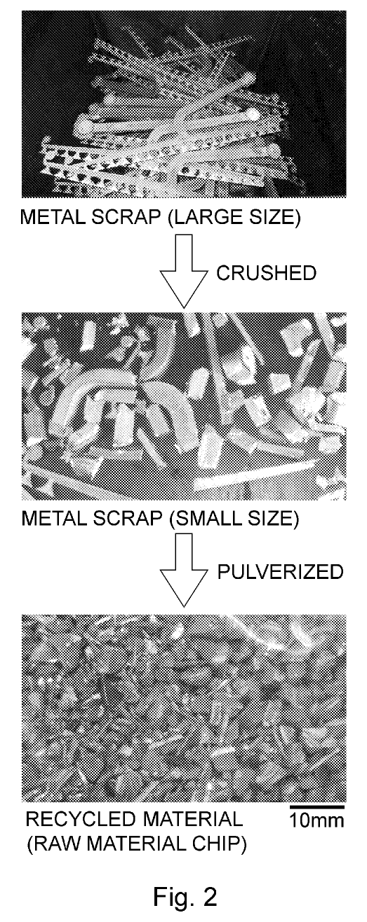

Note that FIG. 2 shows macro photographs showing a process through which raw-material chips made of recycled material are obtained from metal scrap. The upper photograph in FIG. 2 shows metal scrap (large size) generated in the injection molding machine 10. The middle photograph in FIG. 2 shows metal scrap (small size) obtained by crushing the metal scrap (large size) shown in the upper photograph in FIG. 2 by the crusher 20.

The lower photograph in FIG. 2 shows raw-material chips made of recycled material, obtained by pulverizing the metal scrap (small size) shown in the middle photograph in FIG. 2 by the pulverizer 30. The size of raw-material chips is not limited to any particular sizes. The size, e.g., the width, of raw-material chips shown in the lower photograph in FIG. 2 is in the order of several millimeters, which is roughly equal to the size of the virgin material.

### Configuration of Injection Molding Machine

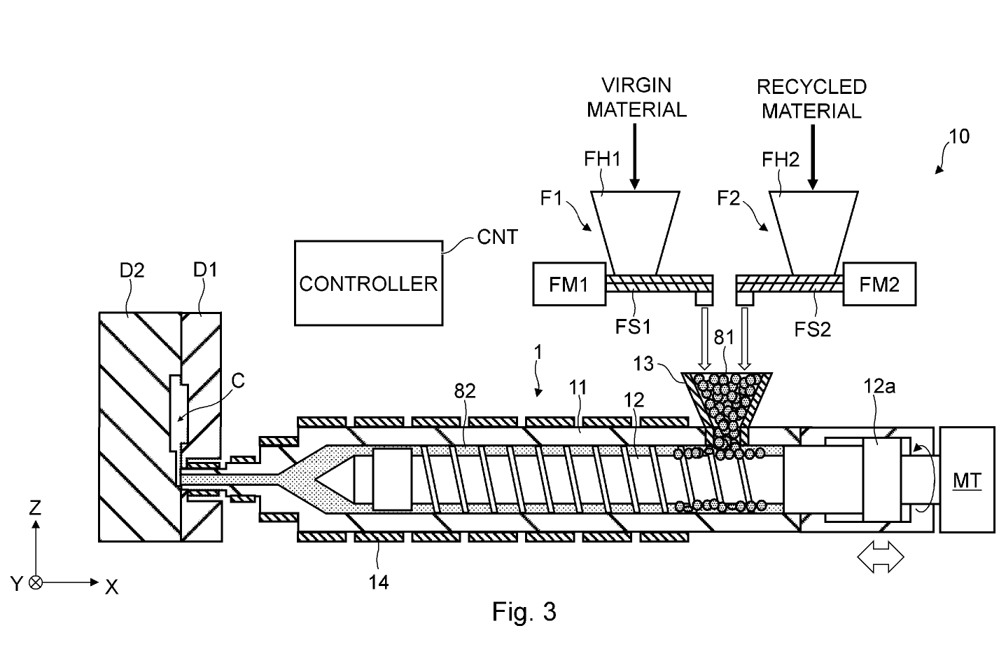

Next, a configuration of an injection molding machine according to the first embodiment will be described with reference to FIGS. 3 to 5. FIGS. 3 to 5 are schematic cross-sectional diagrams showing the configuration of the injection molding machine according to the first embodiment.

Note that, needless to say, right-handed XYZ orthogonal coordinate systems shown in FIGS. 3 to 5 are shown just for the sake of explaining the positional relationship among components. In general, the Z-axis positive direction is the vertically upward direction, and the XY plane is a horizontal plane, which are common throughout the drawings.

As shown in FIGS. 3 to 5, the injection molding machine 10 according to this embodiment includes a feeder F1, a feeder F2, an injection machine 1, a fixed die D1, a movable die D2, and a controller CNT. Note that the injection machine 1 includes a barrel 11, a screw 12, a hopper 13, and annular heaters 14.

FIG. 3 shows a state immediately before molten metal 82 is injected into a cavity C of the mold (fixed die D1 and movable die D2) in the injection molding machine.

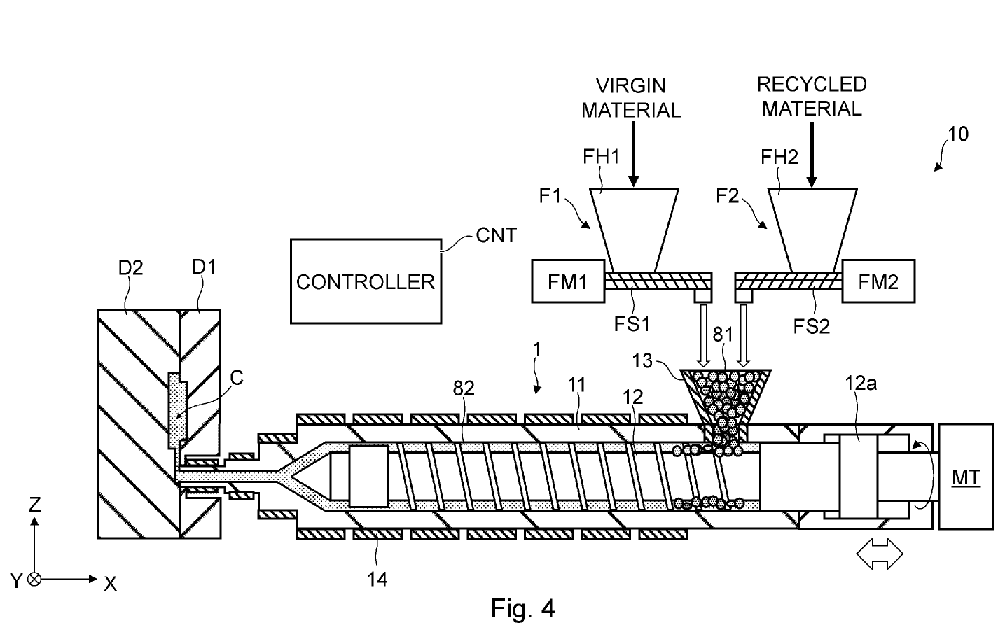

FIG. 4 shows a state after the injection of the molten metal 82 into the cavity C of the mold has been completed in the injection molding machine.

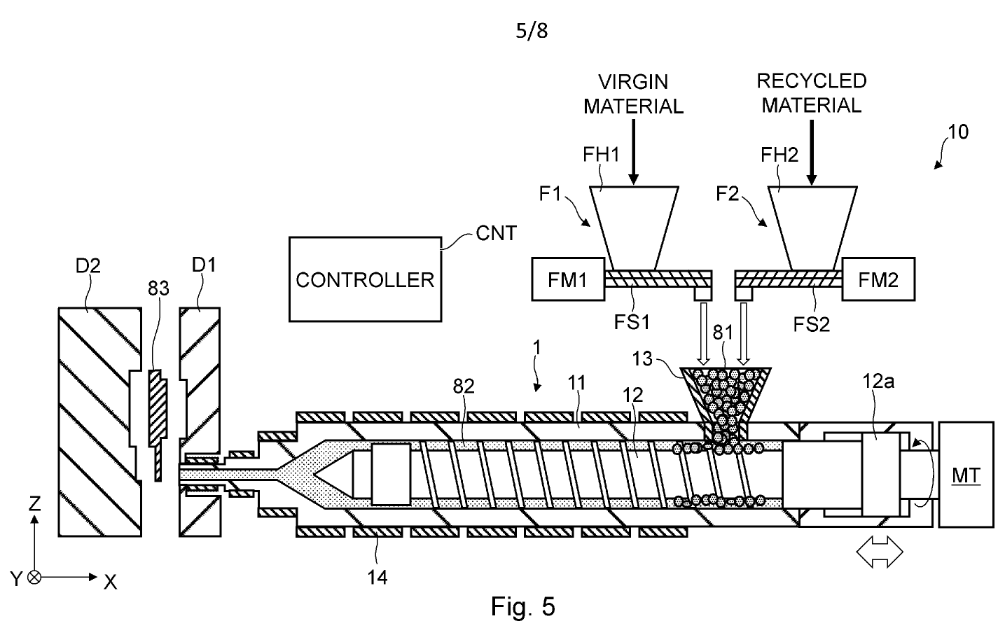

FIG. 5 shows a state in which a metal molded article 83 is taken out from the mold in the injection molding machine.

The feeder (first feeder) F1 is a feeder for supplying raw-material chips made of virgin material into the barrel 11 of the injection machine 1. The feeder F1 shown in FIGS. 3 to 5 is a screw-type feeder and includes a feeder hopper FH1, a feeder screw FS1, and a feeder motor FM1.

Raw-material chips made of virgin material are fed into the feeder hopper FH1 and stored therein. When the feeder screw FS1 is driven and rotated by the feeder motor FM1, the raw-material chips made of virgin material stored in the feeder hopper FH1 are supplied into the barrel 11 of the injection machine 1 through the hopper 13 thereof. For example, it is possible to control the amount of raw-material chips made of virgin material supplied from the feeder F1 to the injection machine 1 by measuring the change in the mass of the raw-material chips made of virgin material stored in the feeder hopper FH1 and feedback-controlling the rotation of the feeder motor FM1 based on the measured change.

Specifically, the amount of raw-material chips made of virgin material supplied from the feeder F1 to the injection machine 1 is controlled by the controller CNT shown in FIGS. 3 to 5. Although the feeder F1 shown in FIGS. 3 to 5 is a screw-type feeder, a vibration-type feeder or other types of feeders may be used as long as the amount of supplied raw-material chips made of virgin material can be controlled by the controller CNT, i.e., by a computer.

The feeder F2 (second feeder) is a feeder for supplying raw-material chips made of recycled material into the barrel 11 of the injection machine 1. The feeder F2 shown in FIGS. 3 to 5 is a screw-type feeder and includes a feeder hopper FH2, a feeder screw FS2, and a feeder motor FM2.

Raw-material chips made of recycled material are fed into the feeder hopper FH2 and stored therein. When the feeder screw FS2 is driven and rotated by the feeder motor FM2, the raw-material chips made of recycled material stored in the feeder hopper FH2 are supplied into the barrel 11 of the injection machine 1 through the hopper 13 thereof. For example, it is possible to control the amount of raw-material chips made of recycled material supplied from the feeder F2 to the injection machine 1 by measuring the change in the mass of the raw-material chips made of recycled material stored in the feeder hopper FH2 and feedback-controlling the rotation of the feeder motor FM2 based on the measured change.

Specifically, the amount of raw-material chips made of recycled material supplied from the feeder F2 to the injection machine 1 is controlled by the controller CNT shown in FIGS. 3 to 5. Although the feeder F2 shown in FIGS. 3 to 5 is a screw-type feeder, a vibration-type feeder or other types of feeders may be used as long as the amount of supplied raw-material chips made of recycled material can be controlled by the controller CNT, i.e., by a computer.

As described above, in the injection molding machine 10 according to this embodiment, the controller CNT controls the feeders F1 and F2 so as to add the recycled material to the virgin material at a mass ratio within a predetermined range. Note that it is possible to prevent the concentration of Fe from exceeding the upper limit value by reducing the mass ratio of the recycled material. Meanwhile, it is possible to reduce the manufacturing cost by increasing the mass ratio of the recycled material.

That is, in the injection molding machine 10 according to this embodiment, it is possible to prevent the concentration of Fe from exceeding the upper limit value and reduce the manufacturing cost at the same time by controlling the feeders or the like so as to add the recycled material to the virgin material at a mass ratio within a predetermined range.

Note that the mass ratio within the predetermined range at which the concentration of Fe can be prevented from exceeding the upper limit value and the manufacturing cost can be reduced can be obtained, for example, by carrying out experiments or the like.

Next, the injection molding machine 1 will be described.

As shown in FIGS. 3 to 5, the barrel 11 is a cylindrical member extending in the X-axis direction. The distal end (the end on the X-axis negative side) of the barrel 11 is narrowed in a stepwise manner and formed in a nozzle-like shape. In the example shown in the drawing, the distal end of the barrel 11 is narrowed in three stages, and the outermost distal end of the barrel 11 is inserted into a through hole provided in the fixed die D1.

The screw 12 extends in the X-axis direction and is housed in the barrel 11 in such a manner that the screw 12 can be rotated and moved forward and backward. The root part (the end on the X-axis positive side) of the screw 12 is connected to a motor MT which is a rotational drive source through a piston 12a. Since the piston 12a can be moved in the X-axis direction by an actuator (not shown), the screw 12 can also be moved in the X-axis direction. As shown in FIG. 4, as the screw 12 moves forward in the X-axis negative direction, molten metal 82 is injected into the mold (fixed die D1 and movable die D2). The rotation and forward/backward movement of the screw 12 are controlled, for example, by the controller CNT.

The hopper 13 is a cylindrical member for feeding raw-material chips 81 made of virgin material and recycled material, which are the raw material of molten metal 82 shown in FIG. 3, into the barrel 11. The hopper 13 is provided above the end of the barrel 11 in the X-axis positive side.

The annular heaters 14 are arranged along the longitudinal direction (X-axis direction) of the barrel 11 so as to cover the outer peripheral surface of the barrel 11. In the examples shown in FIGS. 3 to 5, ten annular heaters 14 are provided on the distal end side (X-axis negative side) of the hopper 13. Each of a plurality of annular heaters 14 is individually controlled, for example, by the controller CNT.

In the injection molding machine 10 according to the first embodiment, raw-material chips 81 supplied from the hopper 13 are sheared (i.e., cut) by the rotating screw 12 while being heated by the annular heaters 14 inside the barrel 11, and thereby are changed into molten metal 82.

The fixed die D1 is a mold fixed to the distal end of the injection machine 1. Meanwhile, the movable die D2 is a mold that is driven by a drive source (not shown) and is slidable in the X-axis direction.

Firstly, the movable die D2 moves in the X-axis positive direction and abuts against the fixed die D1, thereby, as shown in FIG. 3, forming a cavity C corresponding to (i.e., coinciding with) the shape of a metal molded article 83 to be manufactured between the fixed die D1 and the movable die D2 (see FIG. 5). Such forward/backward movements of the movable die D2 are controlled, for example, by the controller CNT.

Next, as shown in FIG. 4, the screw 12 is moved forward in the X-axis negative direction, so that the inside of the mold (fixed die D1 and movable die D2), i.e., the cavity C, is filled with molten metal 82. As the molten metal 82 solidifies in the cavity C, a metal molded article 83 is molded.

Then, as shown in FIG. 5, the screw 12 is moved backward in the X-axis positive direction, and the movable die D2 is moved in the X-axis negative direction. Then, the metal molded article 83 is released and taken out from the fixed die D1.

As described above, the injection molding machine 10 according to this embodiment includes the feeder F1 for supplying raw-material chips made of virgin material to the barrel, and the feeder F2 for supplying raw-material chips made of recycled material, obtained by pulverizing metal scrap generated from the injection molding machine 10 to the barrel. Further, the controller controls the feeders F1 and F2 so as to add the recycled material to the virgin material at a mass ratio within the predetermined range.

Note that it is possible to prevent the concentration of Fe from exceeding the upper limit value in the metal molded article by reducing the mass ratio of the recycled material. Meanwhile, it is possible to reduce the manufacturing cost of the metal molded article by increasing the mass ratio of the recycled material. That is, in the injection molding machine 10 according to this embodiment, it is possible to prevent the concentration of Fe from exceeding the upper limit value in the metal molded article and reduce the manufacturing cost of the metal molded article at the same time by controlling the feeders or the like so as to add the recycled material to the virgin material at a mass ratio within a predetermined range.

### Second Embodiment

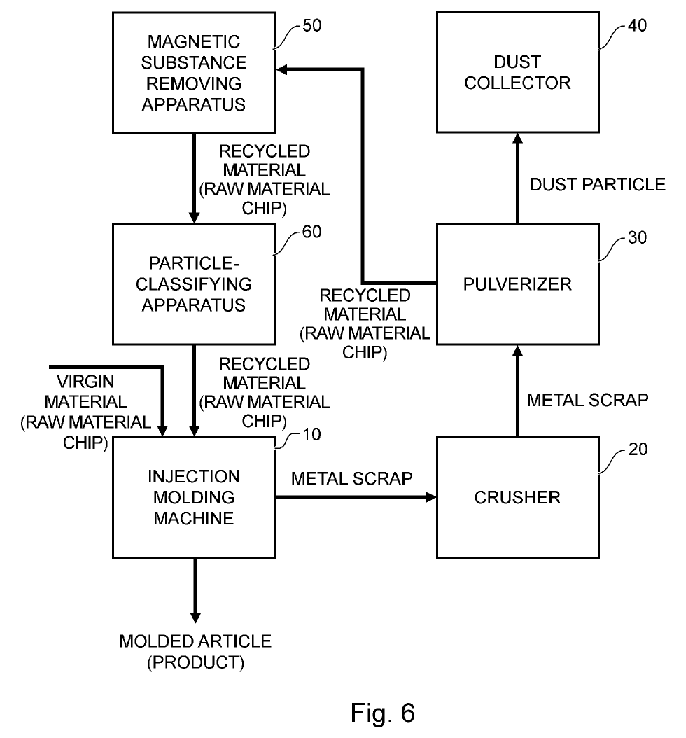

Next, a configuration of a recycling system according to a second embodiment will be described with reference to FIG. 6. FIG. 6 is a block diagram showing the configuration of the recycling system according to the second embodiment. As shown in FIG. 6, the recycling system according to this embodiment includes, in addition to the injection molding machine 10, the crusher 20, and the pulverizer 30 shown in FIG. 1, a dust collector 40, a magnetic substance removing apparatus 50, and a particle-classifying apparatus 60.

The dust collector 40 is connected to the pulverizer 30, and collects dust particles of metal scrap generated in the pulverizer 30. There is a risk that dust particles of, for example, but not limited to, a magnesium alloy ignite in the atmosphere, so that the dust collector 40 is preferably a wet-type dust collector that collects dust particles into water in view of safety and hygiene. By using the wet-type dust collector, it is possible to collect even dust particles of, for example, a magnesium alloy more safely.

The magnetic substance removing apparatus 50 removes magnetic substances from the raw-material chips made of recycled material, obtained by the pulverizer 30. The magnetic substances are, for example, fine iron pieces and the like originating in the injection molding machine 10, the crusher 20, the pulverizer 30, and the like. The magnetic substance removing apparatus 50 is, for example, a magnet filter, and removes magnetic substances by making the raw-material chips made of recycled material pass between magnets (magnets). Then, as shown in FIG. 6, the raw-material chips made of recycled material, from which magnetic substances have been removed by the magnetic substance removing apparatus 50, are fed into the injection molding machine 10.

The magnetic substance removing apparatus 50 can reduce the concentration of Fe contained in the raw-material chips made of recycled material. Therefore, it is possible to increase the mass ratio of the recycled material to the virgin material, and thereby to prevent the concentration of Fe from exceeding the upper limit value in the metal molded article and reduce the manufacturing cost of the metal molded article even further at the same time.

The particle-classifying apparatus 60 classifies the raw-material chips made of recycled material, obtained by the pulverizer 30 according to the size. The particle-classifying apparatus 60 is, for example, a vibration sieving machine. Then, raw-material chips made of recycled material and having a predetermined particle diameter or larger, classified according to the size by the particle-classifying apparatus 60 are fed into the injection molding machine 10.

Note that the positional relationship between the magnetic substance removing apparatus 50 and the particle-classifying apparatus 60 may be reversed. That is, magnetic substances may be removed after the raw-material chips made of recycled material, obtained by the pulverizer 30 are classified according to the size.

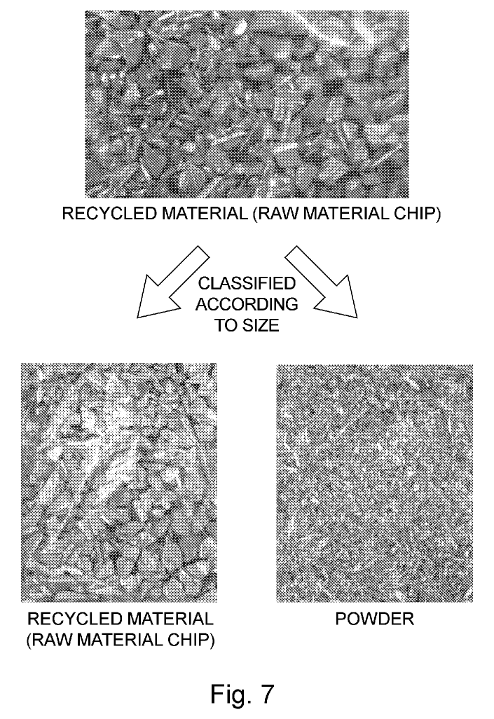

Note that FIG. 7 shows macro photographs showing how raw-material chips made of recycled material are classified according to the size by the particle-classifying apparatus 60. By removing powders contained in the raw-material chips made of recycled material, obtained by the pulverizer 30, it is possible to feed only the raw-material chips made of recycled material and having the predetermined particle diameter or larger into the injection molding machine 10. By the particle-classifying apparatus 60, the bulk density of the raw-material chips made of recycled material and the bulk density of the raw-material chips made of virgin material become roughly equal to each other, so that the mass ratio of the recycled material to the virgin material can be accurately controlled.

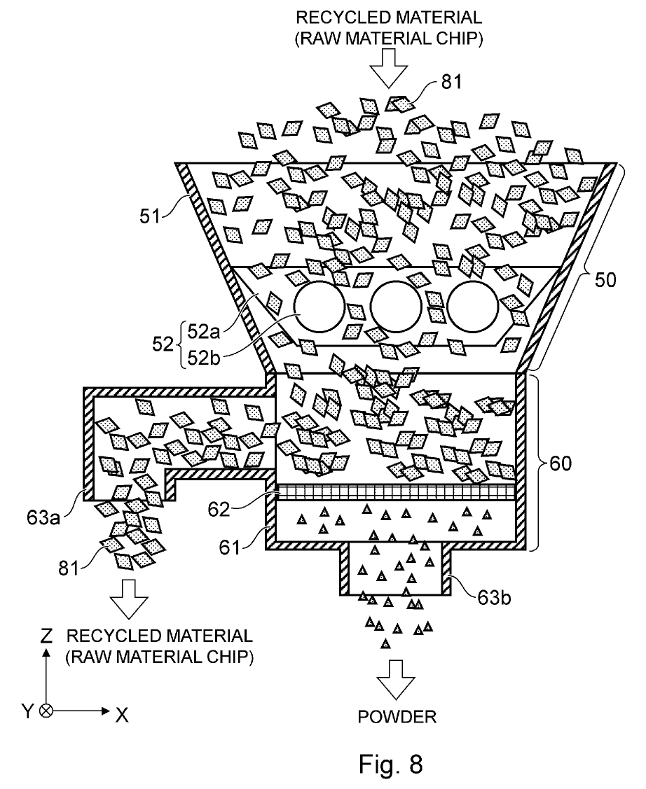

Next, FIG. 8 is a schematic cross-sectional diagram showing an example of the magnetic substance removing apparatus 50 and the particle-classifying apparatus 60. In the example shown in FIG. 8, the magnetic substance removing apparatus 50 is disposed over the particle-classifying apparatus 60, and the magnetic substance removing apparatus 50 and the particle-classifying apparatus 60 are integrally formed.

Note that the configuration of the magnetic substance removing apparatus 50 and the particle-classifying apparatus 60 shown in FIG. 8 is merely an example, and various variations are conceivable.

The magnetic substance removing apparatus 50 includes a hopper 51 and a magnet filter 52. Note that the magnet filter 52 includes support plates 52a and a plurality of magnet bars 52b. Further, the particle-classifying apparatus 60 shown in FIG. 8 is, for example, an electrically-operated vibration sieving machine, and includes a housing 61, a sieve 62, and discharge ports 63a and 63b. Since the particle-classifying apparatus 60 vibrates, the magnetic substance removing apparatus 50 also vibrates.

Firstly, the magnetic substance removing apparatus 50 will be described.

The hopper 51 is, for example, a cylindrical member having a truncated cone shape or a quadrangular pyramid shape, into which raw-material chips 81 made of recycled material, obtained by the pulverizer 30 are fed. The magnet filter 52 is attached inside the hopper 51. The lower end of the hopper 51 is connected to the upper end of the particle-classifying apparatus 60.

Note that raw-material chips 81 made of recycled material, obtained by the pulverizer 30 are conveyed to the feeding port of the hopper 51, for example, by a belt conveyor or the like.

Each of the support plates 52a of the magnet filter 52 shown in FIG. 8 is a plate-like member having a main surface parallel to the XZ plane, and supports the magnet bars 52b. The magnet filter 52 shown in FIG. 8 includes two support plates 52a arranged side by side in the Y-axis direction, but is not limited to any particular configuration.

The plurality of magnet bars 52b shown in FIG. 8 are cylindrical magnets that penetrate the support plates 52a and extend in the Y-axis direction. Magnetic substances are removed from the raw-material chips 81 made of recycled material by making the raw-material chips 81 pass between the plurality of magnet bars 52b. As shown in FIG. 8, the raw-material chips 81 made of recycled material, which have passed through the magnet filter 52, are fed into the particle-classifying apparatus 60.

Note that the magnet filter 52 shown in FIG. 8 includes three magnet bars 52b, but the number of magnet bars 52b is determined as appropriate.

Next, the particle-classifying apparatus 60 will be described.

The housing 61 of the particle-classifying apparatus 60 shown in FIG. 8 is a cylindrical or rectangular cylindrical bottomed cylindrical member formed so as to be connected to the lower end of the hopper 51 of the magnetic substance removing apparatus 50.

The sieve 62 is a mesh member provided horizontally so as to entirely cover the inside of the housing 61 in an XY plane view.

As shown in FIG. 8, a discharge port 63a is provided on the side surface of the housing 61 above the sieve 62. That is, raw-material chips made of recycled material that have not passed through the sieve 62 and hence have the predetermined particle diameter or larger are discharged from the discharge port 63a.

Meanwhile, as shown in FIG. 8, a discharge port 63b is provided on the bottom surface of the housing 61. That is, powders contained in the raw-material chips made of recycled material, obtained by the pulverizer 30 pass through the sieve 62 and are discharged from the discharge port 63b.

Note that in the recycling system according to this embodiment, the configuration of the injection molding machine 10 is also similar to that in the first embodiment. That is, the injection molding machine 10 includes a feeder F1 for supplying raw-material chips made of virgin material to the barrel, and a feeder F2 for supplying raw-material chips made of recycled material, obtained by pulverizing metal scrap generated from the injection molding machine 10 to the barrel. Further, the controller controls the feeders F1 and F2 so as to add the recycled material to the virgin material at a mass ratio within a predetermined range. Therefore, in the recycling system according to this embodiment, it is also possible to prevent the concentration of Fe from exceeding the upper limit value in the metal molded article and reduce the manufacturing cost of the metal molded article at the same time.

Further, as described above, the recycling system according to this embodiment includes the magnetic substance removing apparatus 50 for removing magnetic substances from the raw-material chips made of recycled material, obtained by the pulverizer 30. Therefore, it is possible to reduce the concentration of Fe contained in the raw-material chips made of recycled material. As a result, it is possible to increase the mass ratio of the recycled material to the virgin material, and thereby to prevent the concentration of Fe from exceeding the upper limit value in the metal molded article and reduce the manufacturing cost of the metal molded article even further at the same time.

Further, the recycling system according to this embodiment includes the particle-classifying apparatus 60 for classifying raw-material chips made of recycled material, obtained by the pulverizer 30 according to the size. Therefore, the bulk density of the raw-material chips made of recycled material and the bulk density of the raw-material chips made of virgin material become roughly equal to each other, so that the mass ratio of the recycled material to the virgin material can be accurately controlled.

The rest of the configuration is similar to that in the first embodiment, and therefore the description thereof will be omitted.

Note that the recycling system according to this embodiment may include only one of the dust collector 40, the magnetic substance removing apparatus 50, and the particle-classifying apparatus 60 shown in FIG. 6.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An injection molding machine configured to reuse metal scrap generated in injection molding, comprising:
a barrel in which a screw is housed in such a manner that the screw can be moved forward and backward;
a first feeder configured to supply raw-material chips made of virgin material to a barrel;
a second feeder configured to supply raw-material chips made of recycled material, obtained by pulverizing metal scrap generated from the injection molding machine; and
a controller configured to control the first and second feeders, wherein
the controller controls the first and second feeders so as to add the recycled material to the virgin material at a mass ratio within a predetermined range.

2. The injection molding machine according to claim 1, wherein the raw-material chips are made of a magnesium alloy.

3. A recycling system configured to reuse metal scrap generated in injection molding, comprising:
a crusher configured to crush the metal scrap;
a pulverizer configured to pulverize the crushed metal scrap into raw-material chips; and
an injection molding machine to which raw-material chips made of recycled material, obtained by the pulverizer are supplied, wherein
the injection molding machine comprises:
a barrel in which a screw is housed in such a manner that the screw can be moved forward and backward;
a first feeder configured to supply raw-material chips made of virgin material to a barrel;
a second feeder configured to supply the recycled material to a barrel; and
a controller configured to control the first and second feeders, wherein
the controller controls the first and second feeders so as to add the recycled material to the virgin material at a mass ratio within a predetermined range.

4. The recycling system according to claim 3, wherein the raw-material chips are made of a magnesium alloy.

5. The recycling system according to claim 3, further comprising a magnetic substance removing apparatus configured to remove magnetic substances from the raw-material chips made of recycled material, obtained by the pulverizer, wherein
the raw-material chips made of recycled material, from which the magnetic substances have been removed by the magnetic substance removing apparatus, are fed into the injection molding machine.

6. The recycling system according to claim 5, further comprising a particle-classifying apparatus configured to classify the raw-material chips made of recycled material, obtained by the pulverizer according to size, wherein
the raw-material chips made of recycled material and having a predetermined particle diameter or larger, classified according to the size by the particle-classifying apparatus are fed into the injection molding machine.

7. The recycling system according to claim 3, further comprising a dust collector configured to collect dust particles of the metal scrap generated in the pulverizer.

8. The recycling system according to claim 7, wherein the dust collector is a wet-type dust collector.

9. A recycling method for reusing metal scrap generated in injection molding, comprising the step of:
(a) crushing the metal scrap;
(b) pulverizing the crushed metal scrap into raw-material chips; and
(c) supplying raw-material chips made of recycled material, obtained in the step (b) to an injection molding machine, and thereby performing injection molding, wherein
the injection molding machine comprises:
a barrel in which a screw is housed in such a manner that the screw can be moved forward and backward;
a first feeder configured to supply raw-material chips made of virgin material to a barrel;
a second feeder configured to supply the recycled material to a barrel; and
a controller configured to control the first and second feeders, wherein
in the step (c), the controller controls the first and second feeders so as to add the recycled material to the virgin material at a mass ratio within a predetermined range.

10. The recycling method according to claim 9, wherein the raw-material chips are made of a magnesium alloy.

11. The recycling method according to claim 9, further comprising, after the step (b) and before the step (c), (d) removing magnetic substances from the recycled material obtained in the step (b).

12. The recycling method according to claim 11, wherein
the recycled material obtained in the step (b) is classified according to size, and
the recycled material having a predetermined particle diameter or larger is used in the step (c).

13. The recycling method according to claim 9, wherein dust particles of the metal scrap generated in the step (b) are collected by a dust collector.

14. The recycling method according to claim 13, wherein the dust collector is a wet-type dust collector.
